(19) United States
(12) Patent Application Publication
(10) Pub. No.: US 2005/0121222 A1
(43) Pub. Date: Jun. 9, 2005

(54) Audio and video signal cable

(76) Inventor: Chang-Chi Lee, Hu-Wei Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/725,551

(22) Filed: Dec. 3, 2003

(51) Int. Cl. H01B 11/02

(52) U.S. Cl. 174/113 R

(57) ABSTRACT

An audio and video signal cable consisting of solid conductors of different cross-sectional areas that are parallel arrayed, and after each conductor is insulated, all are surrounded in an insulation, wherein the conductor structure is composed of numerous wires of unequal cross-sectional areas that are furthermore individually insulated. Tinsel, enamel covered wire, or 100% fiber covered copper are utilized for conductors of smaller cross-sectional area, which not only reduces cable outer diameter and increases tensile strength, but also effectively benefits skin effect and enhances high frequency transmission, while larger cross-sectional area conductors facilitate rapid low frequency passage. As such, the present invention is capable of high- and low-frequency band phase synchronicity as well as optimal balance across all frequencies.

### BACKGROUND OF THE INVENTION

1) Field of the Invention

The invention herein relates to electric cables, specifically an audio and video signal cable consisting of numerous conductors having different cross-sectional areas that provide for the transmission of both audio and video signals.

2) Description of the Prior Art

It is widely known that electric wires and cables utilize conductors for the transmission of signals and, furthermore, conductors of different cross-sectional area are selected according to the magnitude of transmission current. In a conventional audio and video signal cable, the cross-sectional area gauge is based on three main considerations. The first is the amount of transmission current, the second is the tensile strength needed, and the third is the outer diameter required. After the conductor cross-sectional areas are calculated, other factors are considered to select the differing diameters of the conductors.

Skin effect is present as electrical current is transmitted through wire; when current flows through a conductor, a magnetic field is generated around the circumference of the wire. As frequency increases, the magnetic field shifts more of the electrons towards the surface of the conductor such that an electron “vacuum” results inside the middle of the conductor; no electrons pass through the center of the conductor. For example, at a frequency of 1 MHz, the skin depth is 0.19812 mm (95 percent of the current converges at the skin depth along the exterior) and at a frequency of 1 GHz, the skin depth is 0.019812 mm. As such, current transmission is limited to the surface level of conductors, and conductive materials and dimensions in which skin depth is excessive are not useful for signal handling. Therefore, smaller diameter conductors tend to be utilized for high frequency signal transmission because there is very little or no space for electron passage in lesser diameter conductors, which also significantly increases material use efficiency.

The material strength of silver-copper alloy wire is much higher than that of pure copper wire, with the conductivity as well as the strength of the alloy being several times greater. Still the strongest material, silver-copper alloy is easy to process and the most practical for fabricating optimal conductance wire. In audio and video cables, the silver-copper alloy wires utilized have rapid transmission, acoustic mellowness, transparency, and other advantages.

100% fiber covered copper is a single or multiple core conductor that is sleeved in a fiber (such as nylon, etc.), nylon having insulation properties. Utilizing 100% fiber covered copper not only reduces core outer diameter and thus overall cable outer diameter, but also increases tensile strength, thereby prolonging service life.

Enamel covered wire is a high purity, high conductivity conductor coated with one or several layers of insulating enamel that is baked on. Since the insulating enamel on the surface of enamel covered wire is very thin, it has replaced other insulations. Wire insulation outer diameter can be substantially reduced, especially if numerous enamel covered wires are required.

Tinsel is interlaced around numerous nylon or cotton fibers to form a very narrow conductor. Since tinsel has a fibrous center, it is a replacement for conventional conductors with increased tensile strength and bending resistance. The tinsel interlacing approach features greater distance between conductors, enabling a larger surface area that lowers skin effect and benefits high frequency transmission.

### SUMMARY OF THE INVENTION

The objective of the invention herein is to provide an audio and video signal cable capable of solving the technological problems associated with simultaneous transmission at different bands of frequency (i.e., high, medium, and low frequencies) by preventing phase difference occurrences.

To achieve the said objective, the present invention utilizes the following technological means: the conductive section of the audio and video signal cable consists of conductors having different cross-sectional areas and that are parallel arrayed, wherein each conductor is insulated and then twisted together, following which all are surrounded in an insulation.

The solid conductor of the invention herein is cross-sectionally circular and flat in shape.

The round-shaped and the flat-shaped solid conductor of the invention herein are wires of different gauge and, furthermore, disposed in various quantities.

The round-shaped and the flat-shaped solid conductor of the invention herein are fabricated of a silver-copper alloy material.

The small cross-sectional area conductor in the audio and video signal cable of the invention herein is comprised of two or more tinsels.

The small cross-sectional area conductor in the audio and video signal cable of the invention herein is comprised of two or more enamel covered wires.

The small cross-sectional area conductor in the audio and video signal cable of the invention herein is comprised of two or more 100% fiber covered coppers.

Compared to the existent technology, the invention herein utilizes a multi-core audio and video cable, the features of which include an extremely balanced high, medium, and low frequency response for good midrange and, furthermore, better definition. Since the audio and video cable is of a multiple core design, the thickness of each core can be differentiated and, furthermore, all independently insulated. It is commonly known that light gauge wire aids high frequency signal transmission and that heavy gauge wire benefits low frequency signal transmission. As such, the three types of cores are of heavy, light, and ultra light gauges to provide specific conductors for high, medium, and low frequency transmission without mutual interference. The light gauge wires improve high frequency phase characteristics to preserve the highest fidelity and the cleanest audio quality. The separate channels for high, medium, and low frequencies in the audio and video signal cable of the invention herein are capable of remarkably efficient audio and video performance.

### BRIEF DESCRIPTION OF THE INVENTION

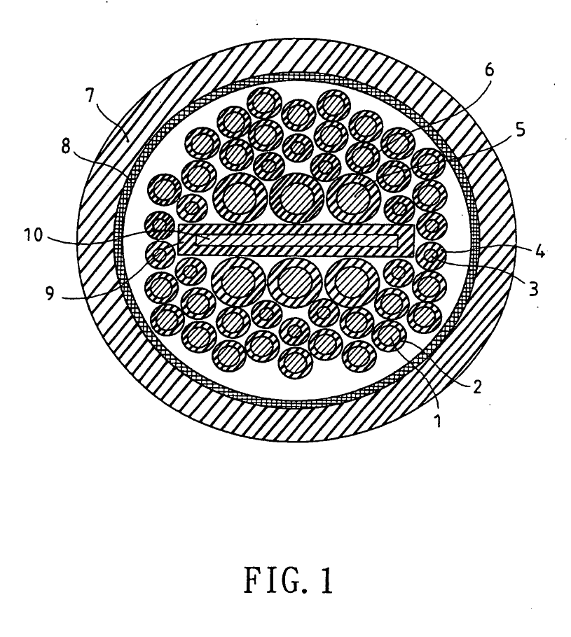

FIG. 1 is a cross-sectional drawing of the first embodiment of the invention herein.

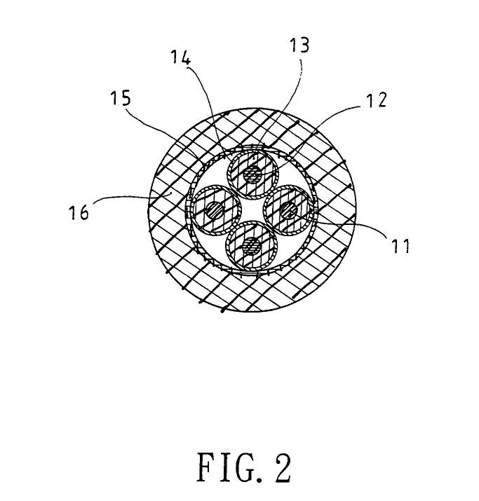

FIG. 2 is a cross-sectional drawing of the second embodiment of the invention herein.

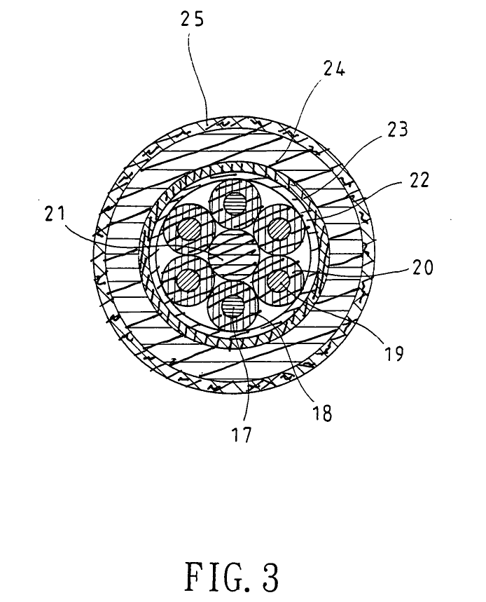

FIG. 3 is a cross-sectional drawing of the third embodiment of the invention herein.

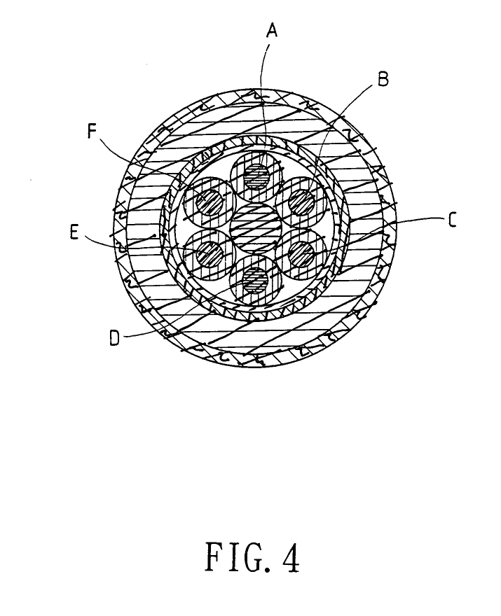

FIG. 4 is a cross-sectional drawing of the third embodiment core numbers of the invention herein.

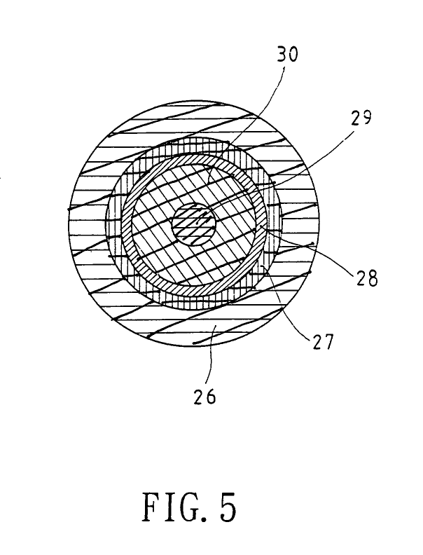

FIG. 5 is a cross-sectional drawing of the fourth embodiment of the invention herein.

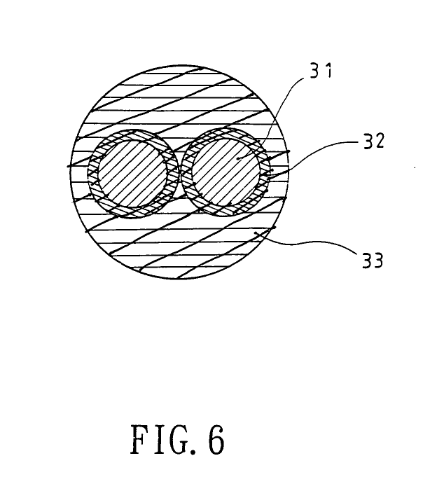

FIG. 6 is a cross-sectional drawing of the fifth embodiment of the invention herein.

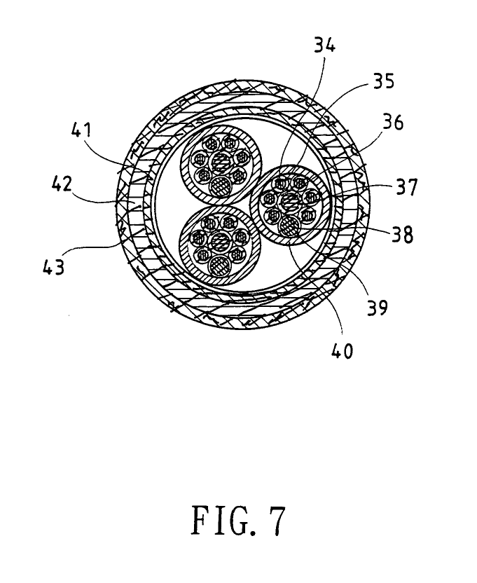

FIG. 7 is a cross-sectional drawing of the sixth embodiment of the invention herein.

### DETAILED DESCRIPTION OF THE INVENTION

Referring to FIG. 1, the cross-sectional drawing of the first embodiment of the invention herein, tinsel 1 and its insulation 2 comprise the first core, the small solid conductor 3 and its insulation 4 comprise another core, the large solid conductor 5 and its insulation 6 comprise the third core, and a cross-sectionally rectangular flat conductor 10 and its insulation 9 comprise the fourth core; the different gauge, varying quantity, and disparate cross-sectional area conductor, cores are assembled and thereafter twisted into a twisted cord, following which the twisted cord exterior is covered by a shielding 8 and then surrounded by insulation 7 to form the first embodiment audio and video signal cable of the invention herein.

In the said first embodiment, the tinsel 1 can be strands enamel covered wire or 100% fiber covered copper.

Referring to FIG. 2, the cross-sectional drawing of the second embodiment of the invention herein, 11 is a solid conductor (two provided), 12 is several strands enamel covered wire (two provided), 13 is insulation, and 14 is conductive PVC. After the solid conductor (11) and the several strands enamel covered wire are insulated, they are twisted into a twisted cord, following which the twisted cord exterior is covered by a shielding 15 and surrounded in insulation 16 to form the second embodiment audio and video signal cable of the invention herein.

In the said second embodiment, the enamel covered 12 can be tinsel or 100% fiber covered copper.

Referring to FIG. 3, the cross-sectional drawing of the third embodiment of the invention herein, 17 is a solid round conductor (two provided), 18 is its insulation, 19 is several strands twisted copper wire (four provided), 20 is its insulation, 21 is a filler, 22 is a conductive PVC, 23 is a shielding, 24 is a total insulation, and 25 is nylon braiding, parts 17 to 25 forming the third embodiment audio and video signal cable of the invention herein.

Referring to FIG. 4, the cross-sectional drawing of the third embodiment core numbers of the invention herein; wires are connected, wherein after the cores A, B, and C are stripped of insulation, they are spliced together into a single conductor; and after the cores D, E, and F are stripped of insulation, they are spliced together into a single conductor.

Referring to FIG. 5, the cross-sectional drawing of the fourth embodiment of the invention herein, 29 is several strands twisted copper wire and numerous tinsels assembled together, 30 is their insulation, 28 is conductive PVC, 27 is a shielding, and 27 is a total insulation, parts 26 to 30 forming the fourth embodiment audio and video signal cable of the invention herein.

Referring to FIG. 6, the cross-sectional drawing of the fifth embodiment of the invention herein, 31 is several strands twisted copper wire (four provided), and 32 is its insulation, and 33 is a total insulation, parts 31 to 33 forming the fifth embodiment audio and video signal cable of the invention herein.

Referring to FIG. 7, the cross-sectional drawing of the sixth embodiment of the invention herein, the small solid conductor 34 and its insulation 35 comprise the first core (six provided), the large solid conductor 36 and its insulation comprise the second core, and several strands twisted copper wire 38 and their insulation comprise the third core; the different gauge, varying quantity, and disparate cross-sectional area conductor, cores are assembled and thereafter twisted into a twisted cord and surrounded by insulation 40. Three such cores are similarly twisted, a shielding 41 is added onto the exterior, which is then surrounded by insulation 42 and nylon braiding 43 to form the sixth embodiment audio and video signal cable of the invention herein.

When the audio and video signal cable is joined to a connector, based on the particular wiring requirements, the said disparate cross-sectional area conductors are stripped of insulation, following which they are spliced together into a single conductor.

In conventional electric wire, the center conductor is typically a single conductor, and if the conductor is too narrow, electrical resistance increases; if the conductor is too large, then high frequency signal passage is difficult. As a result, the invention herein combines numerous leads into a unitary entity to enable a reduction in low- to high-frequency transmission loss; however, since the cross-sectional area of the narrow conductor is smaller, medium/low frequency spectrum signal “throughput” is not as good as that for high frequencies; this is because high frequency signal speed is faster along metal surfaces during transmission and they arrive first, while low frequency signals proceed along the center of conductors at a relatively slower rate and arrive later; utilizing a large wire diameter, conductor facilitates rapid low frequency passage and thereby achieves the objective of high- and low-frequency band phase synchronicity. Therefore, utilizing different thick and thin, individually insulated conductors enables the respective handling of different frequency band signal transmission and as such, takes full advantage of skin effect, while achieving total frequency requirements.

In the invention herein, the said conductor refers to any material capable of electrical conductance; various metals are most often utilized and thus any suitable metallic material can be employed for fabrication, including solid copper or multi-stranded copper wire; silver-, aluminum-, steel- or other metal-based metallic coatings; and metal alloys or other assorted admixtures; the conductor can also be a non-metallic compound material capable of conductivity.

In the invention herein, the said insulation is also known as a dielectric, referring to an appropriate material utilized for electrical cable insulation, including polyethylene, polyvinyl chloride, polypropylene, polyvinyl chloride copolymer, crosslinked polyethylene, rubber, and other materials; the many kinds of insulating materials can also be fortified by the addition of an agent such as a flame retardant and fungi proofing, etc.

1. An audio and video signal cable comprising:
at least one first core comprising tinsel and surrounding insulation, a small solid conductor and its insulation comprise at least one second core, a large solid conductor and its insulation comprise at least one third core, and a cross-sectionally rectangular flat conductor and its insulation comprise at least one fourth core, each of said at least one first, second, third and fourth cores having a gauge and a cross-sectional area associated respectively therewith, each of said respective gauges and cross-sectional areas being selectively chosen depending on the particular application of said audio and video signal cable, each of said cores are assembled and thereafter twisted into a twisted cord, following which the twisted cord exterior is covered by a shielding and then surrounded by insulation to form an audio and video signal cable, whereby said small solid conductor, said large solid conductor and said cross-sectionally rectangular flat conductor are each selected from the group consisting of: a silver-copper alloy, two or more pieces of tinsel, two or more lengths of enamel covered wire and two or more lengths of pure fiber covered copper.

2. The audio and video signal cable as recited in claim 1 wherein the said solid conductor is cross-sectionally circular in shape.

3. The audio and video signal cable as recited claim 1 wherein the said solid conductor is cross-sectionally flat in shape.
